(19) United States
(12) Patent Application Publication
(10) Pub. No.: US 2012/0072900 A1
(43) Pub. Date: Mar. 22, 2012

(54) INFORMATION PROVIDING APPARATUS, INFORMATION PROCESSING APPARATUS, METHOD FOR CONTROLLING THE SAME, AND PROGRAM

(75) Inventor: Takahiro Matsushita, Tokyo (JP)

(73) Assignee: CANON KABUSHIKI KAISHA, Tokyo (JP)

(21) Appl. No.: 13/232,670

(22) Filed: Sep. 14, 2011

(30) Foreign Application Priority Data
Sep. 21, 2010 (JP) 2010-210903
Aug. 22, 2011 (JP) 2011-180361

(51) Int. Cl. G06F 9/44

(52) U.S. Cl. 717/173

(57) ABSTRACT

The present invention facilitates confirming changes important for a user when the information processing apparatus updates a software program. The information processing apparatus of the present invention records the status of use of the software program for each function in a use information management file. The information processing apparatus acquires an update information management file indicating the changes of the software program and a correlation between a function and a model of a device, from an information providing apparatus. The information processing apparatus performs control to generate display data for separately displaying a function on a screen in which the status of use satisfies a predetermined condition and the other functions, among a plurality of changed functions in the update information management file and display a change notification screen on a display device.

### BACKGROUND OF THE INVENTION

1. Field of the Invention

The present invention relates to a technique in which an information processing apparatus downloads update data from an information providing apparatus to update an application software program.

2. Description of the Related Art

Up to now, at the time an information processing apparatus updates an application software program (application), a screen indicating newly added functions or revised functions has been displayed on a display unit.

If there are a large number of changes at the time the information processing apparatus updates an application, it takes much time for a user to look over all the changes or the user passes over necessary information.

### SUMMARY OF THE INVENTION

The present invention is directed to facilitate confirmation of changes by a user at the time the information processing apparatus updates an application.

According to an aspect of the present invention, an information processing apparatus which downloads update data from an information providing apparatus and updates a software program with the update data includes a reception unit configured to receive an update information management file indicating changes of the software program updated with the update data for each function from the information providing apparatus, a recording unit configured to record the status of use of the software program for each function in a use information management file, and a generation unit configured to generate display data for separately displaying a function on a screen in which the status of use of the use information management file satisfies a predetermined condition, and the other functions, among a plurality of changed functions in the update information management file.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of configuration of an information providing apparatus and an information processing apparatus.

FIG. 2 illustrates an example of a change notification screen.

FIG. 3 illustrates an example of a change notification screen.

FIG. 4 illustrates an example of an update information management file.

FIG. 5 illustrates an example of a use information management file.

FIG. 6 is a flow chart illustrating an example of the operation of the information processing apparatus.

FIG. 7 is a flow chart illustrating an example of the operation of the information processing apparatus.

### DESCRIPTION OF THE EMBODIMENTS

Various exemplary embodiments, features, and aspects of the invention will be described in detail below with reference to the drawings.

The components described in the present exemplary embodiment are merely examples and the scope of the present invention is not limited only to those components.

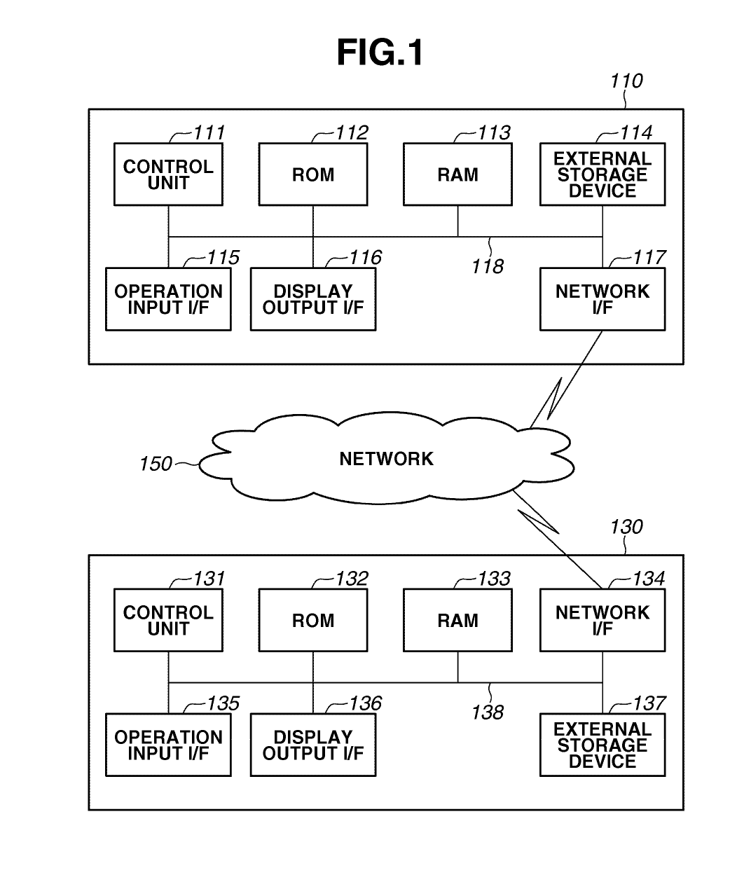

FIG. 1 is a block diagram illustrating an example of configuration of an information providing apparatus 110 and an information processing apparatus 130. The information providing apparatus 110 and the information processing apparatus 130 are realized by a computer apparatus such as a personal computer. Each of the information providing apparatus 110 and the information processing apparatus 130 may be realized by a single computer apparatus, or realized by distributing each function to a plurality of computer apparatuses according to need. If the information providing apparatus 110 and the information processing apparatus 130 are comprised of a plurality of computer apparatuses, the information providing apparatus 110 and the information processing apparatus 130 are communicably connected to each other via a local area network (LAN).

A control unit 111 is a central processing unit (CPU), for example, and controls the entire information providing apparatus 110. A read only memory (ROM) 112 stores programs and parameters which do not need to be changed. A random access memory (RAM) 113 temporarily stores programs and data supplied from an external apparatus. An external storage device 114 is a hard disk or a memory card fixed to the information providing apparatus 110, or an optical disk such as a compact disk (CD), a floppy disk (FD) or, an IC card, a magnetic or optical card, detachable from the information providing apparatus 110. An operation input interface 115 receives the operation of the user and connects with an input device such as a pointing device or a keyboard for inputting data. A display output interface 116 connects with a display unit configured to display the data stored in the information providing apparatus 110, or the supplied data. A network interface 117 connects with a network circuit such as the Internet 103. A system bus 118 communicably connects the units 111 to 117 to one another.

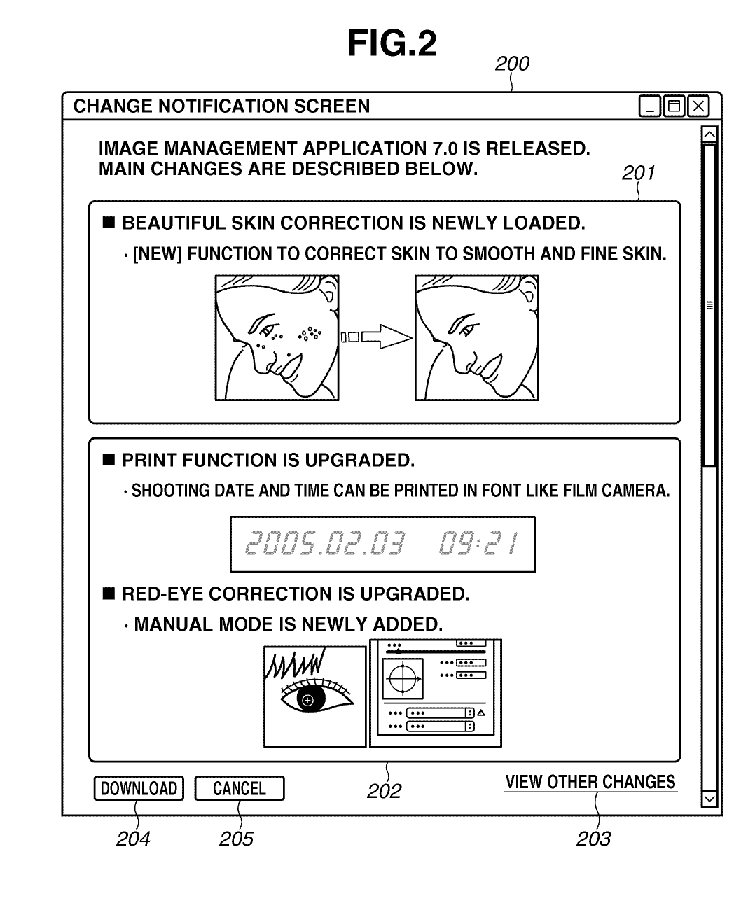

Units 131 to 137 of the information processing apparatus 130 are similar to the units 111 to 117 of the information providing apparatus 110. FIG. 2 illustrates an example of a change notification screen 200 which the information processing apparatus 130 displays on the display unit. The change notification screen 200 displays information 201 about newly added functions and information about functions satisfying the after-mentioned conditions. When the control unit 131 detects that the user clicks the link 203, a change notification screen 300 for other functions is displayed.

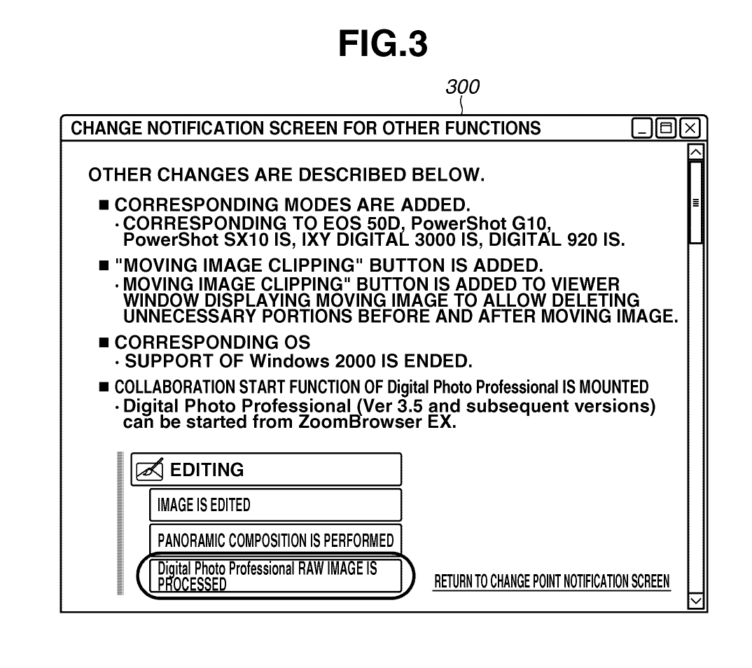

FIG. 3 illustrates an example of a change notification screen 300 for other functions which the information processing apparatus 130 displays on the display unit. The change notification screen 300 for other functions displays information about functions excluding the newly added functions and functions satisfying predetermined conditions. In other words, the change notification screen 300 for other functions displays information about the rest of the functions which are not displayed on the change notification screen 200.

In the present exemplary embodiment, when the information processing apparatus 130 starts the application software program (application), the information processing apparatus 130 is connected to the information providing apparatus 110 via the network 150 and receives the latest version of the application. The information processing apparatus 130 compares the latest version of the application received from the information providing apparatus 110 with the version of the application currently installed. As a result of the comparison, if the version of the application installed in the information processing apparatus 130 is not the latest version, the information processing apparatus 130 requests the information providing apparatus 110 to transmit an update information management file indicating the changes of the latest version. The information providing apparatus 110 reads the update information management file from the external storage device 114 and transmits the file to the information processing apparatus 130. The information processing apparatus 130 reads a use information management file, a connection model management file, and a display condition management file from an external storage device 137 and generates an update notification list based on those files and the update information management file. The information processing apparatus 130 generates the change notification screen 200 about update information related to the functions that exist in the update notification list and displays the change notification screen 200 on the display unit. The information processing apparatus 130 generates the change notification screen 300 for other functions about update information related to the functions that exist in the update information management file but not in the update notification list and displays the change notification screen 300 for other functions on the display unit.

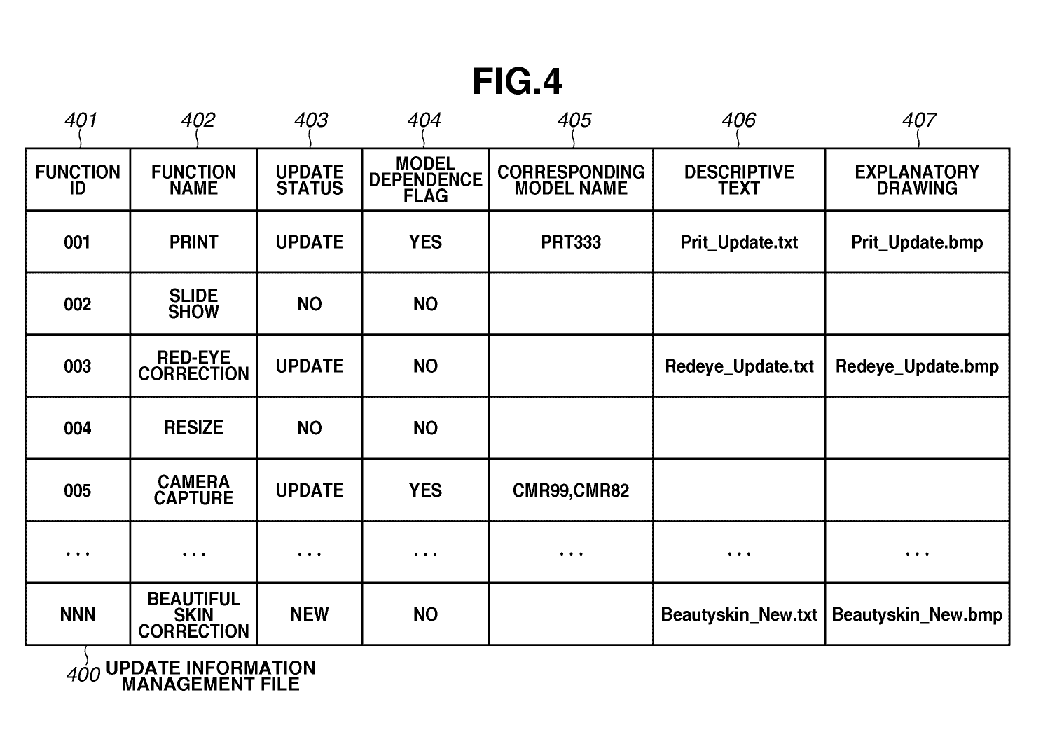

FIG. 4 illustrates an example of the update information management file. The information providing apparatus 110 generates an update information management file 400 according to the operator's operation every time the version of an application is changed to another version thereof and stores the file 400 into the external storage device 114. FIG. 4 illustrates the update information management file in a case where the version 6.0 of the application is changed to the version 7.0 thereof. The update information management file has update information, for each function, including a function ID 401 for uniquely identifying a function, a function name 402, an update status 403 indicating the update status, a model dependence flag 404 indicating whether a function depends on a model, a corresponding model name 405 in a case where a function depends on a model, a file path 406 to a text file representing descriptive text indicating the contents of update, and a file path 407 to a bit map file representing an explanatory drawing. For the update status 403, a newly added function is represented by “NEW,” an updated function is represented by “UPDATE,” and a function with no change is represented by “NO.” If a function depends on a model, “YES” is entered in the column of the model dependence flag 404. If a function does not depend on a model, “NO” is entered in the column of the model dependence flag 404. For example, if “a function is to capture an image from a camera” or “a function to develop an image file of a format inherent in a camera” which depends on the model of a camera, “YES” is entered in the column of the model dependence flag 404 and a correspondence model name is “XXX-345.”

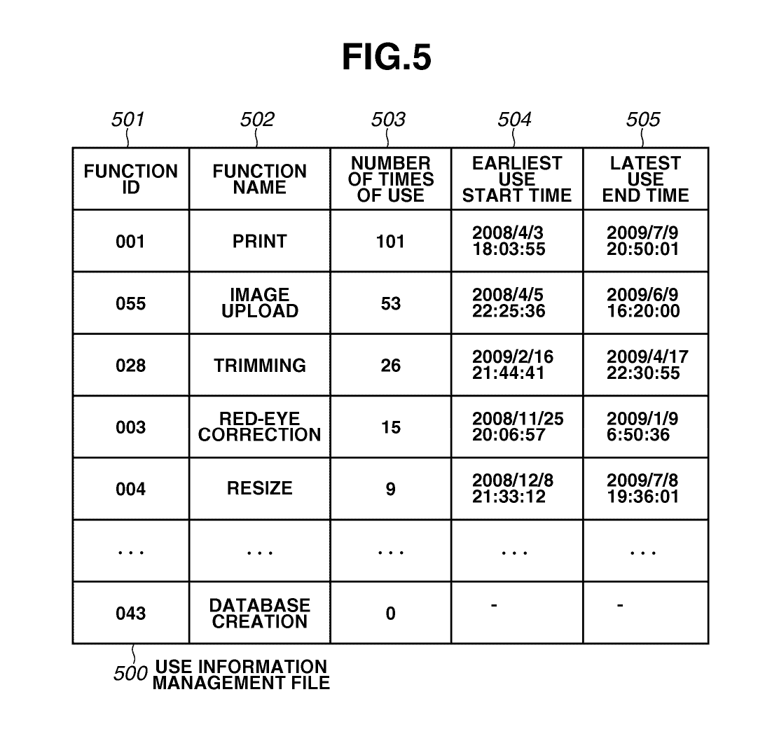

FIG. 5 illustrates an example of a use information management file. The information processing apparatus 130 creates a use information management file 500 for each application and stores the file 500 in the external storage device 137. The use information management file 500 includes use information, for each function, such as a function ID 501, a function name 502, the number of times of use 503, the earliest use start time 504, and the latest use end time 505. A use frequency can be obtained by dividing the number of times of use 503 by a time period from the earliest use start time 504 to the latest use end time 505.

When the information processing apparatus 130 detects connection with a device, the information processing apparatus 130 records the model name of the device and the latest connection date and time in the connection model management file and stores the file in the external storage device 137. The device is a digital camera and a printer, for example.

The information processing apparatus 130 records the upper limit of the number of functions and the lower limit of the number of times of use displayed on the change notification screen in the display condition management file in response to the operation of the user and stores the file in the external storage device 137. The display condition management file may be created for each application or a single file may be created for all the applications.

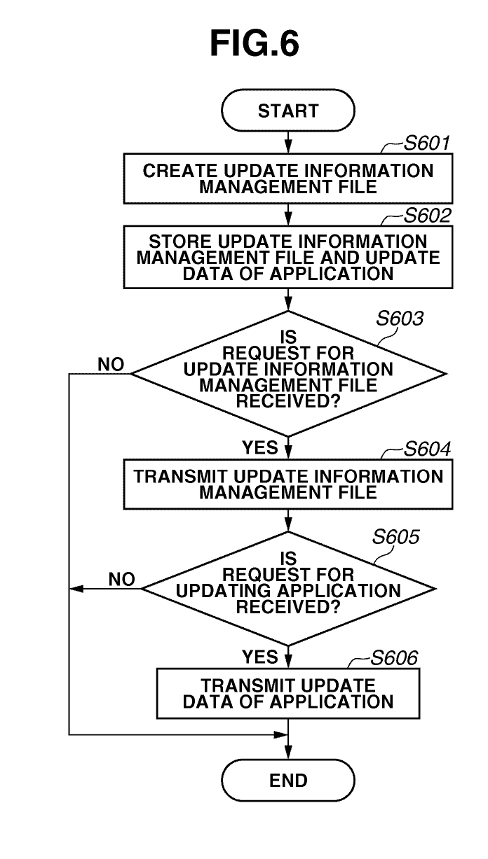

The operation is described below with reference to FIG. 6 in which the information providing apparatus 110 of the present exemplary embodiment transmits the update information management file of the application and update data to the information processing apparatus 130. In step S601, when the application is updated, the control unit 111 of the information providing apparatus 110 creates the update information management file indicating update contents in the latest version from the application whose version is obsolete in response to the operation of the user. In step S602, the update information management file and the update data of the application are stored in the external storage device 114. In step S603, the control unit 111 determines whether the information providing apparatus 110 receives the request for the update information management file from the information processing apparatus 130. If the information providing apparatus 110 receives the request (YES in step S603), in step S604, the control unit 111 reads the update information management file from the external storage device 114 and transmits the update information management file to the information processing apparatus 130. Thereafter, in step S605, the control unit 111 determines whether the information providing apparatus 110 receives the request for update data of the application from the information processing apparatus 130. If the information providing apparatus 110 receives the request (YES in step S605), in step S606, the control unit 111 reads the update data of the application from the external storage device 114 and transmits the update data of the application to the information processing apparatus 130.

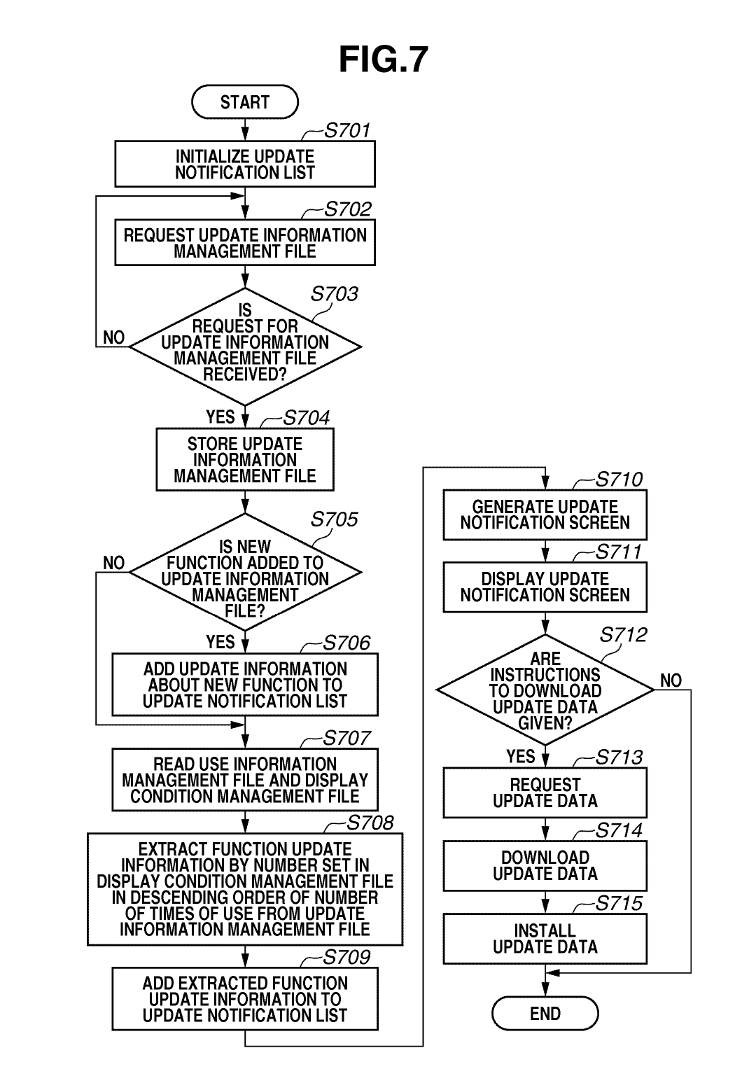

The operation is described below with reference to FIG. 7 in which the information processing apparatus 130 receives the update information management file of the application from the information providing apparatus 110 and displays the change notification screen on the display unit. In step S701, the control unit 131 of the information processing apparatus 130 starts an update executing program of the application to initialize the update notification list stored in the external storage device 137 in response to the operation of the user. The control unit 131 executes the subsequent processing according to the update executing program and the OS. In step S702, the control unit 131 transmits the request for the update information management file to the information providing apparatus 110. In step S703, the control unit 131 determines whether the update information management file is received from the information providing apparatus 110. If the control unit 131 determines that the update information management file is not received (NO in step S703), in step S702, the control unit 131 transmits again the request for the update information management file to the information providing apparatus 110. If the control unit 131 determines that the update information management file is received (YES in step S703), in step S704, the control unit 131 stores the update information management file in the external storage device 114. In step S705, the control unit 131 determines whether a new function is added to the update information management file. If a function of “NEW” is entered in the column of the update status 403 of the update information management file 400 (YES in step S705), the control unit 131 determines that a new function is added thereto. In step S705, if the control unit 131 determines that a new function is added, in step S706, the update information corresponding to the new function is extracted from the update information management file 400 and added to update notification list. In step S707, the control unit 131 reads the use information management file and the display condition management file from the external storage device 114.

In step S708, the control unit 131 extracts the update information of functions of a number which is set in the display condition management file in descending order of number of use times 503 in the use information management file 500 among “UPDATE” functions of the update status 403 of the update information management file 400. In step S709, the control unit 131 adds the extracted update information of function to the update notification list. In step S710, the control unit 131 generates displaying data for the change notification screen 200 and the change notification screen 300 for other functions according to the update notification list. In step S711, the control unit 131 displays the displaying data on the display unit.

In step S710, the control unit 131 generates the displaying data for the change notification screen 200 to display the update information of the function described in the update notification list. The control unit 131 generates the displaying data for the change notification screen 300 for other functions to display the update information of the function which exists in the update information management file but is not described in the update notification list. Thus, the update information about new functions and more frequently used functions is displayed on the change notification screen 300 to allow the user to facilitate the confirmation of more frequently used functions and new functions, preventing the user from overlooking information about functions significantly required.

In step S710 of the present exemplary embodiment, the displaying data are generated so that the change notification screen 200 and the change notification screen 300 for other functions are displayed as other dependent screens. Instead, the displaying data may be generated so that the change notification screen 200 and the change notification screen 300 for other functions can be displayed on the same screen. In this case, the change notification screen 200 is displayed above the change notification screen 300 for other functions. Alternatively, the change notification screen 200 is displayed and after that the change notification screen 300 for other functions may be displayed. Still alternatively, only the change notification screen 200 is displayed first, and the change notification screen 300 for other functions may be changed from non-display to display in response to the instructions from the user. In other words, the change notification screen 200 and the change notification screen 300 for other functions have only to be displayed so that the user can easily identify them.

In step S712, the control unit 131 determines whether the user browses the change notification screen 200 and the change notification screen 300 for other functions and then presses a download button 204 to instruct the download of the update data. If the control unit 131 determines that the download is instructed (YES in step S712), in step S713, the control unit 131 requests the information providing apparatus 110 to transmit the update data of the application. In step S714, the control unit 131 downloads the update data of the application from the information providing apparatus 110 and, in step S715, the control unit 131 installs the update data of the application in the external storage device 137. On the other hand, when the user presses a cancel button 205, if the control unit 131 determines that the download is not instructed (NO in step S712), the control unit 131 ends the processing. Incidentally, in step S708, the control unit 131 may extract functions whose use frequency is higher than the value set in the display condition management file instead of functions whose number of use times is large from the use information management file.

Alternatively, the control unit 131 may extract any function name from the use information management file used during the time period which lies within the latest use finish time set in the display condition management file. This facilitates the user's confirmation of functions which have been recently used.

Still alternatively, the three conditions may be properly combined so that function names satisfying the conditions are extracted. Prior to step S705, the functions with the model dependence flag 404 as “YES” corresponding to the model name 405 that does not exist in the connection model management file may be excluded from a notification target with reference to the update information management file 400 and then the connection model management file and the processing of step S706 and subsequent steps may be executed. This facilitates the user to confirm functions related to the model of the device owned by the user.

When the update data are installed in step S715 or the updated application is first started, the information about the status of use of each function in the use information management file may be reset. This instantly makes higher the number of use times of a new function in a case where, while the user has used the old function in a previous version many times for a long time period, the user is fond of a new function in a new version and starts using the new function without using the old function. This reflects the status of use in the present version and displays the change notification screen according to the user's desire.

In the present exemplary embodiment, the operation is described in which the information processing apparatus 130 receives the update information management file from the information providing apparatus 110, generates the change notification screen, and displays the screen on the display unit. Other than that, the information providing apparatus 110 may receive the use information management file, the display condition management file, and the connection model management file from the information processing apparatus 130, generate the change notification screen, transmit the screen to the information processing apparatus 130, and display the screen on the display unit of the information processing apparatus 130.

In the present exemplary embodiment, the information processing apparatus 130 displays the change notification screen in step S713 and then downloads the update data from the information providing apparatus 110 in step S714, and installs the update data in step S715. However, before the information processing apparatus 130 displays the change notification screen 200 in step S713, the information processing apparatus 130 may download the update data from the information providing apparatus 110, and install the update data. In other words, the change notification screen 200 is displayed after the processing of downloading and installing the update data is started. This enables the user of the information processing apparatus 130 to confirm changes related to the function of the latest application while the user waits until the download and the installation of the update data are ended, which makes the confirmation efficient. In this case, the information processing apparatus 130 has only to request the information providing apparatus 110 to transmit the update data along with the update information management file. In the present exemplary embodiment, a case is described where the information processing apparatus 130 is realized by using a computer apparatus such as a personal computer, however, the information processing apparatus 130 may be realized by using a terminal such as a digital camera, a smart phone, and an electronic book equipped with an information processing function and a communication processing function instead.

As described above, in the present exemplary embodiment, not all functions, but only changes related to new functions and more frequently used functions are displayed on the change notification screen at the time the application is upgraded. Thereby, the user can easily confirm changes related to functions important for the user, reducing risk of overlooking the changes. Further, the user does not need reading changes related to functions which the user does not use, which reduces the burden of the user.

### Other Embodiments

The present invention can also be realized by executing the following processing. More specifically, the processing is performed such that software (program) realizing the functions of the foregoing exemplary embodiment is supplied to a system or an apparatus via a network or various storage media and the computer (or CPU or MPU) of the system or the apparatus reads and executes the program.

The functions of the above exemplary embodiment are not only realized by executing program codes read by the computer. For example, an operation system (OS) operating on the computer performs a part or the whole of actual processing based on instructions of the program codes and the functions of the exemplary embodiment is realized by the processing. Furthermore, the functions of the above exemplary embodiment is realized by the processing in which the program codes read from the storage medium are written in a memory included in a function expansion board inserted into the computer or a function expansion unit connected to the computer and a CPU included in the function expansion board or the function expansion unit performs apart or the whole of actual processing based on instructions of the program codes.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a process recorded on a memory device to perform the functions of the above-described embodiment(s). For this purpose, the process is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-210903 filed Sep. 21, 2010 and No. 2011-180361 filed Aug. 22, 2011 which are hereby incorporated by reference herein in their entirety.

What is claimed is:

1. An information processing apparatus which downloads update data from an information providing apparatus and updates a software program with the update data, the apparatus comprising:
a reception unit configured to receive an update information management file indicating changes of the software program updated with the update data for each function, from the information providing apparatus;
a recording unit configured to record the status of use of the software program for each function in a use information management file; and
a generation unit configured to generate display data for separately displaying a function on a screen in which the status of use of the use information management file satisfies a predetermined condition, and the other functions, among a plurality of changed functions in the update information management file.

2. The information processing apparatus according to claim 1, further comprising a display unit configured to display the display data generated by the generation unit after the update data are downloaded and the software program is updated by the update data.

3. The information processing apparatus according to claim 1, wherein the status of use is the frequency of use of each function in the current version of the software program.

4. The information processing apparatus according to claim 1, wherein the recording unit is configured to record a device connected to the information processing apparatus in a connection model management file, the update information management file indicates that each changed function corresponds to the model of the device, and the function satisfying the condition, to which the model corresponds, among a plurality of functions in the update information management file, is recorded in the connection model management file.

5. The information processing apparatus according to claim 1, wherein the generation unit configured to generate display data for displaying a function in which the status of use of the use information management file satisfies a predetermined condition, and the other functions, on their respective independent screens.

6. A method for controlling an information processing apparatus which downloads update data from an information providing apparatus and updates a software program with the update data, the method comprising:
receiving an update information management file indicating changes of the software program updated with the update data for each function, from the information providing apparatus;
recording the status of use of the software program for each function in a use information management file; and
generating display data for separately displaying a function on a screen in which the status of use of the use information management file satisfies a predetermined condition, and the other functions, among a plurality of changed functions in the update information management file based on the use information management file.

7. A computer-readable storage medium storing a computer-executable process, the computer-executable process causing a computer realizing an information processing apparatus which downloads update data from an information providing apparatus and updates a software program with the update data to perform a method comprising:
receiving an update information management file indicating changes of the software program updated with the update data for each function from the information providing apparatus;
recording the status of use of the software program for each function in a use information management file; and
generating display data for separately displaying a function on a screen in which the status of use of the use information management file satisfies a predetermined condition, and the other functions, among a plurality of changed functions in the update information management file.
